(19) United States
(12) Patent Application Publication
(10) Pub. No.: US 2020/0173539 A1
(43) Pub. Date: Jun. 4, 2020

(54) SHIFT DEVICE

(71) Applicant: AISIN SEIKI KABUSHIKI KAISHA, Kariya-shi, Aichi-ken (JP)

(72) Inventor: Junya NAKAMURA, Kuwana-shi, Mie-ken (JP)

(73) Assignee: AISIN SEIKI KABUSHIKI KAISHA, Kariya-shi, Aichi-ken (JP)

(21) Appl. No.: 16/615,634

(22) PCT Filed: Mar. 1, 2018
(86) PCT No.: PCT/JP2018/007749

§ 371 Date: Nov. 21, 2019

(30) Foreign Application Priority Data
May 26, 2017 (JP) 2017-104266

(51) Int. Cl. F16H 59/08; F16H 61/24; B60K 20/02; F16H 61/02

(52) U.S. Cl. CPC F16H 59/08; F16H 61/24; F16H 2061/0087; F16H 61/0202; B60K 20/02

(57) ABSTRACT

A control section of this shift device is configured to perform a learning process regarding a relative position of a shift switching mechanism section for a rotation drive section when transition from a non-startup state to a startup state occurs on the basis of both of a change amount of a drive section rotation angle in the non-startup state and the startup state and a change amount of a switching mechanism section turning angle in the non-startup state and the startup state.

### TECHNICAL FIELD

The present invention relates to a shift device.

### BACKGROUND ART

In the related art, there is a shift device including a shift switching mechanism section switching shift positions. Such a shift device is disclosed in, for example, Japanese Patent No. 5605254.

Japanese Patent No. 5605254 discloses a shift-by-wire device (shift device) is provided with a control device that includes a motor (rotation drive section) moving a position of a manual lever and is configured to move the manual lever depending on a position of a lever operated by a vehicle's driver, and a microcomputer (control section). The control device of the shift-by-wire device disclosed in Japanese Patent No. 5605254 includes an encoder that outputs a signal for each rotation angle of the motor. The microcomputer is configured to acquire a rotation position of the motor by counting a signal from the encoder. The microcomputer is configured to switch between a wakeup state (startup state) of driving the motor and a sleep state (non-startup state) of reducing power consumption by stopping or reducing the supply of power to the motor and some equipment.

Here, in the shift-by-wire device disclosed in Japanese Patent No. 5605254, in a case where a rotation position of the motor changes due to vibration or the like in the sleep state, the device is configured to perform initialization or the like (learning process) of a rotation position when a change occurs from the sleep state to the wakeup state. In the shift-by-wire device disclosed in Japanese Patent No. 5605254, in order to perform the initialization or the like of a rotation position, power is supplied to the encoder detecting a rotation angle of the motor even in the sleep state. In the shift-by-wire device disclosed in Japanese Patent No. 5605254, in a case where there is a change in a signal from the encoder, the microcomputer is configured to restart up, switch to the wakeup, and resume the supply of power to equipment such as the motor.

### CITATION LIST

### Patent Literature

[PTL 1] Japanese Patent No. 5605254

### SUMMARY OF INVENTION

### Technical Problem

However, in the shift-by-wire device (shift device) disclosed in Japanese Patent No. 5605254, in order to perform the initialization or the like of a rotation position, power is supplied to the encoder even in the sleep state, and thus there is a problem in that power consumption in the sleep state (non-startup state) cannot be sufficiently reduced. In a case where there is a change in a signal from the encoder, the microcomputer restarts up and switches to the wakeup state, and thus there is also a problem in that power consumption further increases in the shift-by-wire device.

The present invention has been made to solve the problems, and an object of the present invention is to provide a shift device capable of performing a learning process regarding a relative position of a shift switching mechanism section when transition from a non-startup state to a startup state occurs while reducing power consumption.

### Solution to Problem

In order to achieve the object, according to one aspect of the present invention, there is provided a shift device including a shift switching mechanism section that switches shift positions; a rotation drive section that is configured to switch between a startup state and a non-startup state, and generates rotation drive force for turnably driving the shift switching mechanism section; a drive section rotation angle detection section that detects a drive section rotation angle due to rotation drive of the rotation drive section; a switching mechanism section turning angle detection section that detects a switching mechanism section turning angle due to turning drive of the shift switching mechanism section; and a control section that controls the rotation drive section, in which the control section is configured to perform a learning process regarding a relative position of the shift switching mechanism section with respect to the rotation drive section when transition from the non-startup state to the startup state occurs on the basis of both of a change amount of the drive section rotation angle in the non-startup state and the startup state and a change amount of the switching mechanism section turning angle in the non-startup state and the startup state.

As described above, the shift device according to the aspect of the present invention includes the drive section rotation angle detection section that detects a drive section rotation angle and the switching mechanism section turning angle detection section that a switching mechanism section turning angle. The control section is configured to perform a learning process regarding a relative position of the shift switching mechanism section for the rotation drive section when transition from the non-startup state to the startup state occurs on the basis of both of a change amount of the drive section rotation angle in the non-startup state and the startup state and a change amount of the switching mechanism section turning angle in the non-startup state and the startup state. Consequently, it is possible to perform a learning process regarding a relative position of the shift switching mechanism section when transition from the non-startup state to the startup state occurs on the basis of a change amount of the rotor rotation angle and a change amount of the switching mechanism section turning angle in the non-startup state and the startup state even though neither the drive section rotation angle detection section nor the switching mechanism section turning angle detection section is subjected to conduction in the non-startup state. As a result, it is possible to sufficiently reduce power consumption in the non-startup state of the shift device. In the non-startup state, switching to the startup state is not required according to an output change of the drive section rotation angle detection section or the switching mechanism section turning angle detection section, and thus it is possible to suppress an increase in power consumption in the shift device. As a result, it is possible to perform a learning process regarding a relative position of the shift switching mechanism section when transition from the non-startup state to the startup state occurs while reducing power consumption in the shift device.

As described above, the shift device according to the aspect of the present invention includes the drive section rotation angle detection section and the switching mechanism section turning angle detection section. Consequently, even in a case where a signal from one of the drive section rotation angle detection section and the switching mechanism section turning angle detection section does not change, it is possible to reliably recognize a rotation position or the like of the rotation drive section by using a detection result in the other of the drive section rotation angle detection section and the switching mechanism section turning angle detection section. As a result, it is possible to appropriately perform shift position switching control in the shift device.

In the shift device according to the aspect, preferably, the shift switching mechanism section is configured to switch between a driven-turn state in which the shift switching mechanism section is turnably driven in accordance with rotation drive of the rotation drive section and a non-driven-turn state in which the shift switching mechanism section is not turnably driven in accordance with rotation drive of the rotation drive section, and the shift switching mechanism section is configured to switch from the non-driven-turn state to the driven-turn state within a range in which the rotation drive section is turnably driven by below one rotation in terms of electrical angle.

With this configuration, in the non-driven-turn state, it is possible to suppress the rotation drive section from being rotated by one or more rotations in terms of electrical angle. Consequently, for example, even in a case where a signal from the switching mechanism section turning angle detection section does not change due to the non-driven-turn state of the shift switching mechanism section, the shift switching mechanism section can switch to the driven-turn state before a case occurs in which the rotation drive section is rotated by one or more rotations in terms of electrical angle and thus signals from the drive section rotation angle detection section are the same as each other. Therefore, it is possible to suppress that shift position switching control cannot be appropriately performed in the shift device.

In this case, preferably, the shift device further includes a drive force transfer mechanism that includes a drive section side member provided on the rotation drive section side and a driven section side member provided on the shift switching mechanism section side and turned due to turning of the drive section side member, and that transfers drive force from the rotation drive section side to turnably drive the shift switching mechanism section, and a predetermined amount of a looseness is provided between the drive section side member and the driven section side member, and thus the shift switching mechanism section is configured to switch from the non-driven-turn state to the driven-turn state within a range in which the rotation drive section is turnably driven by below one rotation in terms of electrical angle.

With this configuration, the shift switching mechanism section can be easily configured to switch from the non-driven-turn state to the driven-turn state in a range in which the rotation drive section is turnably driven by below one rotation in terms of electrical angle by using the drive force transfer mechanism in which the predetermined amount of looseness is provided between the drive section side member and the driven section side member. A rotation speed or the like of the rotation drive section can be configured to be appropriately changed when turning drive force is transferred to the shift switching mechanism section, by using the drive force transfer mechanism having the drive section side member and the driven section side member.

Preferably, the shift device according to the aspect further includes a storage section that stores information regarding the drive section rotation angle and information regarding the switching mechanism section turning angle, the control section is configured to, when transition to the non-startup state occurs, store the information regarding the drive section rotation angle and the information regarding the switching mechanism section turning angle into the storage section, and then to stop the supply of power to the drive section rotation angle detection section and the switching mechanism section turning angle detection section, and the control section is configured to, when transition to the startup state occurs, resume the supply of power to the drive section rotation angle detection section and the switching mechanism section turning angle detection section, to acquire the information regarding the drive section rotation angle and the information regarding the switching mechanism section turning angle stored in the storage section, and to acquire the change amount of the drive section rotation angle in the non-startup state and the startup state and the change amount of the switching mechanism section turning angle in the non-startup state and the startup state.

With this configuration, the control section acquires the information regarding the drive section rotation angle and the information regarding the switching mechanism section turning angle stored into the storage section when transition to the non-startup state occurs, during transition to the startup state, and can thus perform a learning process regarding a relative position of the shift switching mechanism section for the rotation drive section. The control section is configured to store information regarding a drive section rotation angle and information regarding a switching mechanism section turning angle into the storage section, and then stop the supply of power to the drive section rotation angle detection section and the switching mechanism section turning angle detection section. Consequently, it is possible to quickly and reliably reduce power consumption in the shift device while storing the information regarding the drive section rotation angle and the information regarding the switching mechanism section turning angle.

In the shift device according to the aspect, preferably, the control section is configured to perform a learning process regarding the relative position of the shift switching mechanism section when return from the non-startup state to the startup state occurs in a case where the change amount of the drive section rotation angle in the non-startup state and the startup state is equal to or more than a drive section threshold value, or in a case where the change amount of the switching mechanism section turning angle in the non-startup state and the startup state is equal to or more than a switching mechanism section threshold value.

With this configuration, in a case where the change amount is less than the change amount of the drive section rotation angle in the non-startup state and the startup state is less than a drive section threshold value, and the change amount of the switching mechanism section turning angle in the non-startup state and the startup state is less than a switching mechanism section threshold value, the control section can be configured not to perform a learning process, and thus it is possible to suppress an unnecessary learning process in the shift device. Consequently, in a case where, for example, wall abutment control (control of learning a reference position by rotating the rotation drive section to the limit of a movable range) is performed as a learning process, it is possible to suppress an unnecessary load from being applied to the rotation drive section or the like.

In the shift device according to the aspect, preferably, the switching mechanism section turning angle detection section includes a magnetic force generation portion that is not turned and is stationary, and a magnetic force detection portion that is turned along with the shift switching mechanism section, and the magnetic force generation portion is disposed in a circular arc shape over a range wider than a turning range of the shift switching mechanism section.

With this configuration, the magnetic force detection portion can reliably perform detection in the entire turning range of the shift switching mechanism section.

In the shift device further including the drive force transfer mechanism having the drive section side member and the driven section side member, preferably, the drive section side member includes a first engagement portion, and the driven section side member includes a second engagement portion that is engaged with the first engagement portion with the predetermined amount of looseness and to which drive force from the drive section side member is transferred.

With this configuration, relative free turning (free rotation) between the drive section side member and the driven section side member can be allowed in proportion to a predetermined amount of looseness occurring between the first engagement portion and the second engagement portion engaged with each other, and thus it is possible to easily secure the non-driven-turn state.

In the shift device including the driven section side member having the second engagement portion engaged with the first engagement portion with the predetermined amount of looseness, preferably, the first engagement portion is a long hole that extends in a circular arc shape in a turning direction, the second engagement portion is a columnar protrusion that has an outer diameter of the substantially same length as a length of the long hole in a width direction, and is inserted into the long hole, and the predetermined amount of looseness has a length excluding a length occupied by the columnar protrusion from a length of the long hole in a longitudinal direction.

With this configuration, the predetermined amount of looseness is provided between the long hole and the columnar protrusion, and thus the shift switching mechanism section can be easily configured to switch from the non-driven-turn state to the driven-turn state in a range in which the rotation drive section is turnably driven by below one rotation in terms of electrical angle.

Preferably, the shift device according to the aspect further includes a drive force transfer mechanism that transmits drive force from the rotation drive section side to turnably drive the shift switching mechanism section, and the shift switching mechanism section includes an output shaft portion that is coupled to the drive force transfer mechanism and in which the switching mechanism section turning angle is detected by the switching mechanism section turning angle detection section.

With this configuration, a turning angle of the output shaft coupled to the drive force transfer mechanism is used as a turning angle of the shift switching mechanism section, and thus the shift device can be configured to easily detect a switching mechanism section turning angle.

### BRIEF DESCRIPTION OF DRAWINGS

FIG. 1 is a block diagram illustrating a control configuration of a shift device according to first and second embodiments of the present invention.

FIG. 2 is a perspective view schematically illustrating the overall configuration of the shift device according to the first embodiment of the present invention.

FIG. 3 is a diagram illustrating a detent plate configuring the shift device according to the first embodiment of the present invention.

FIG. 4 is a sectional view illustrating an actuator unit configuring the shift device according to the first embodiment of the present invention.

FIG. 5 is a diagram illustrating a structure of a deceleration mechanism section in the actuator unit configuring the shift device according to the first embodiment of the present invention.

FIG. 6 is a plan view for describing a turning range of a final gear configuring the shift device according to the first embodiment of the present invention.

FIG. 7 is a diagram illustrating states (driven-turn states) of an intermediate gear on a motor side and an intermediate gear on a shift switching mechanism section side configuring the shift device according to the first embodiment of the present invention.

FIG. 8 is a diagram illustrating states (non-driven-turn states) of the intermediate gear on the motor side and the intermediate gear on the shift switching mechanism section side configuring the shift device according to the first embodiment of the present invention.

FIG. 9 is a diagram for describing changes in a pattern number and an output voltage in the shift device according to the first embodiment of the present invention.

FIG. 10 illustrates a control flow in an ECU during transition to a sleep state in the shift device according to the first embodiment of the present invention.

FIG. 11 illustrates a control flow in the ECU during transition to a wakeup state in the shift device according to the first embodiment of the present invention.

FIG. 12 illustrates a control flow in an ECU during transition to a wakeup state in the shift device according to a second embodiment of the present invention.

### DESCRIPTION OF EMBODIMENTS

Hereinafter, embodiments of the present invention will be described with reference to the drawings.

### First Embodiment

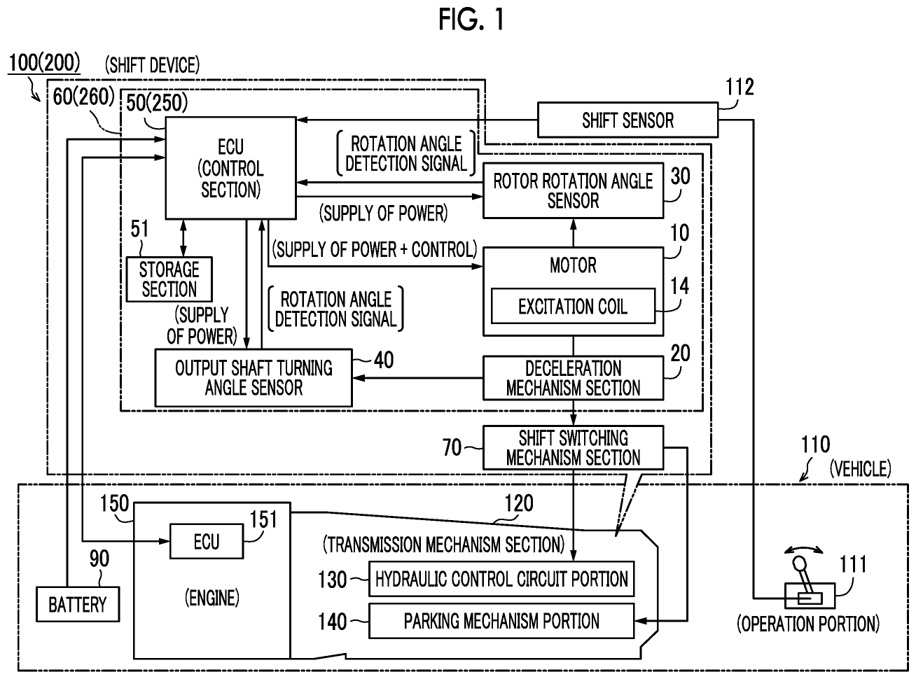

First, with reference to FIGS. 1 to 8, a description will be made of a configuration of a shift device 100 according to a first embodiment of the present invention.

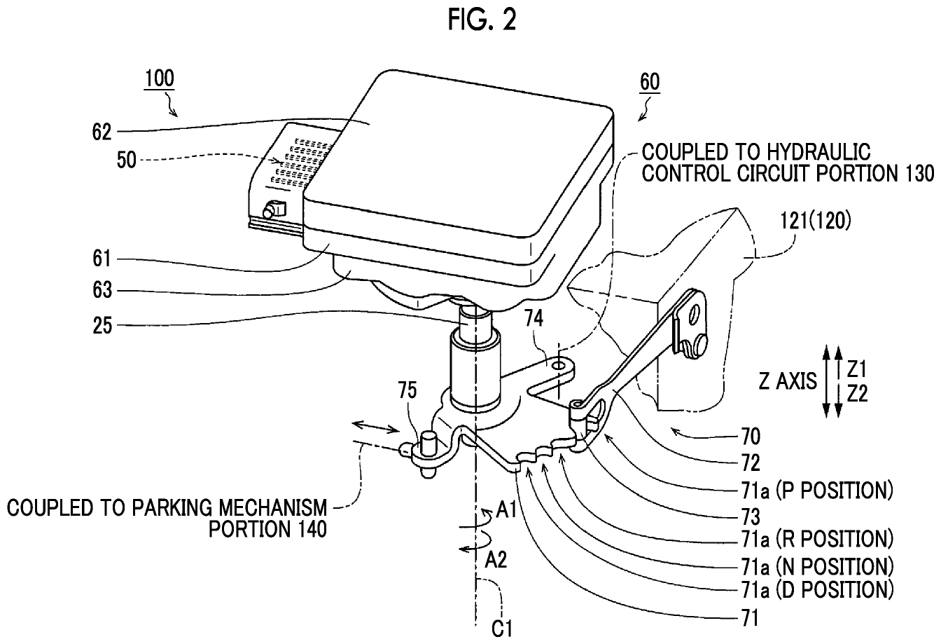

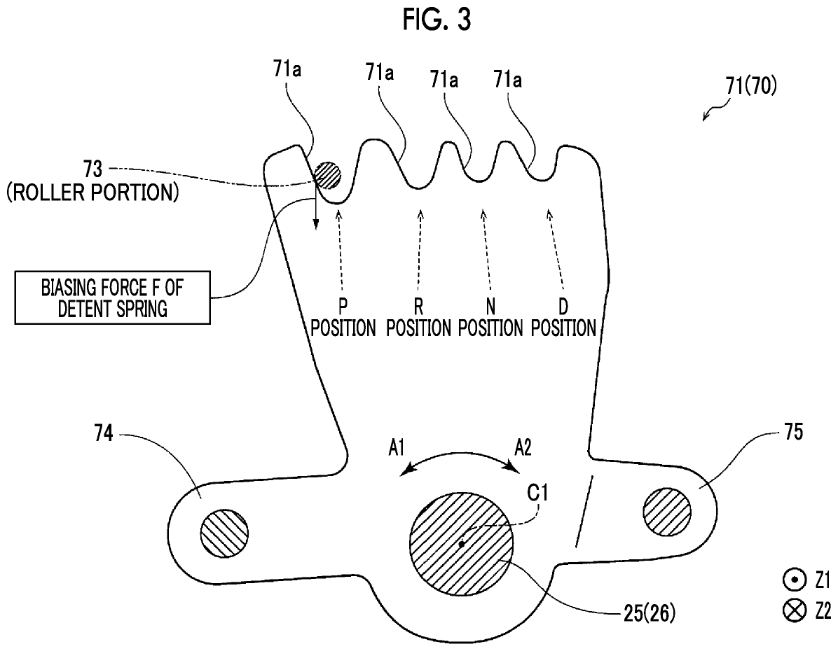

The shift device 100 according to the first embodiment of the present invention is mounted on a vehicle 110 such as an automobile. As illustrated in FIG. 1, in the vehicle 110, in a case where an occupant (driver) performs a shift switching operation via an operation portion 111 such as a shift lever (or a shift switch), electrical shift position switching control is performed on a transmission mechanism section 120. In other words, a position of the shift lever is input to the shift device 100 side via a shift sensor 112 provided in the operation portion 111. The transmission mechanism section 120 switches to any one shift position (refer to FIGS. 2 and 3) of a parking (P) position, a reverse (R) position, a neutral (N) position, and a drive (D) position corresponding to a surface operation of the occupant on the basis of a control signal transmitted from a dedicated ECU 50 (an example of a control section) provided in the shift device 100. Such shift position switching control is referred to as shift-by-wire (SBW).

The shift device 100 includes an actuator unit 60 and a shift switching mechanism section 70 driven by the actuator unit 60. As illustrated in FIG. 2, the shift switching mechanism section 70 is mechanically coupled to a hydraulic control circuit portion 130 and a parking mechanism portion 140 of transmission mechanism section 120. The shift switching mechanism section 70 is driven, and thus a shift position of the transmission mechanism section 120 is configured to be mechanically switched.

(Configuration of Shift Switching Mechanism Section)

As illustrated in FIG. 2, the shift switching mechanism section 70 includes a detent plate 71 and a detent spring 72. As illustrated in FIG. 3, the detent plate 71 has four valley parts 71a respectively corresponding to the P position, the R position, the N position, and the D position. The detent spring 72 has a function of holding (fixing) the detent plate 71 at any one shift position of the four valley parts 71a. Specifically, the detent spring 72 has one end fixed to a casing 121 (refer to FIG. 2) of the transmission mechanism section 120 and the other end attached to a roller portion 73. The roller portion 73 is biased toward an output shaft 25 side which will be described later by the detent spring 72, and thus the roller portion 73 is configured to be fitted into any one of the four valley parts 71a.

As illustrated in FIG. 2, the detent plate 71 is fixed to a lower end (Z2 side) of the output shaft 25, and thus the detent plate 71 is turned about a turning axis line C1 integrally with the output shaft 25. Consequently, in the detent spring 72, the roller portion 73 is slid due to forward and backward turning (oscillation) of the detent plate 71 in an arrow A1 direction or an arrow A2 direction. The shift switching mechanism section 70 is configured such that a shift position is held by biasing force F from the detent spring 72 in a state in which the slid roller portion 73 is fitted into any one of the valley parts 71a.

The detent plate 71 further includes an arm part 74 and an arm part 75. The arm part 74 is coupled to the hydraulic control circuit portion 130. The hydraulic control circuit portion 130 is configured such that a hydraulic circuit corresponding to each shift position is formed when a shift position is switched to any one position other than the P position. The arm part 75 is coupled to the parking mechanism portion 140. The parking mechanism portion 140 is configured to restrict rotation of a crank shaft (not illustrated) when a shift position is switched to the P position, and not to restrict rotation of the crank shaft when a shift position is switched to any one position other than the P position.

(Configuration of Actuator Unit)

As illustrated in FIG. 1, the actuator unit 60 includes a motor 10 (an example of a rotation drive section), a deceleration mechanism section 20 (an example of a drive force transfer mechanism), a rotor rotation angle sensor 30 (an example of a drive section rotation angle detection section), an output shaft turning angle sensor 40 (an example of a switching mechanism section turning angle detection section), the ECU 50 (an example of a control section), and a storage section 51. The actuator unit 60 further includes the output shaft 25 (an example of an output shaft portion) that is connected to an output side of the deceleration mechanism section 20 and is turnable about the turning axis line C1.

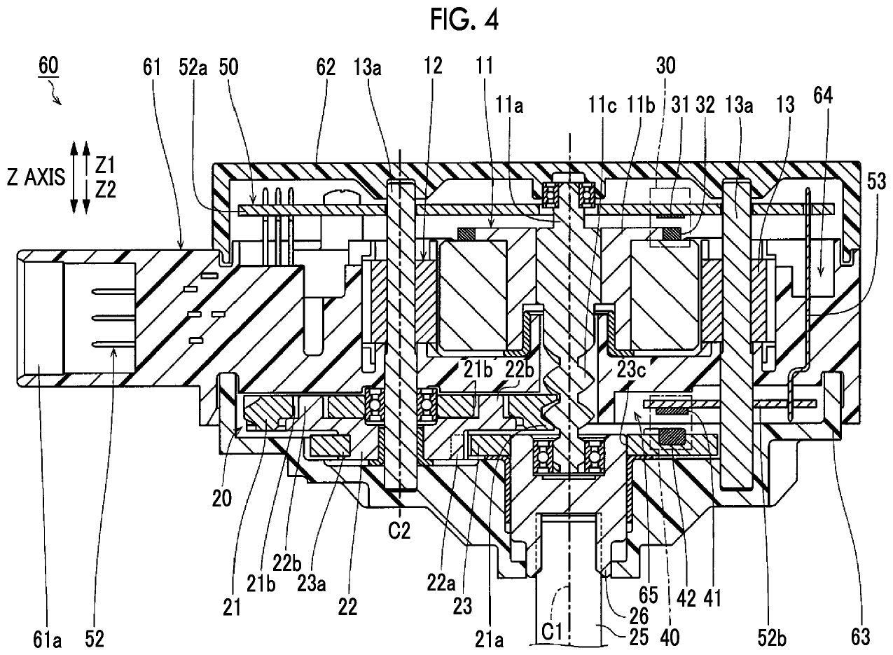

The ECU 50 is a board component in which electronic components are mounted on a board 52a (refer to FIG. 4). The ECU 50 is electrically coupled to the motor 10, the rotor rotation angle sensor 30, and the output shaft turning angle sensor 40. Consequently, the ECU 50 is configured to control the supply of power to the motor 10, the rotor rotation angle sensor 30, and the output shaft turning angle sensor 40 from a battery 90 of the vehicle 110. The ECU 50 is configured to receive rotor rotation angle information (digital signal) regarding a rotation angle of a rotor 11 which will be described later from the rotor rotation angle sensor 30, and is configured to receive plate turning angle information (output voltage) regarding an output shaft turning angle (plate turning angle) of the output shaft 25 (detent plate 71) from the output shaft turning angle sensor 40. The ECU 50 can perform communication with an ECU 151 that controls an engine 150 mounted on the vehicle 110.

The storage section 51 includes a nonvolatile memory. The storage section 51 is configured to store rotor rotation angle information and plate turning angle information during transition to the sleep state which will be described later.

As illustrated in FIG. 4, the actuator unit 60 has an appearance formed by a motor housing 61, a motor cover 62, and a gear housing 63. A motor room 64 accommodating the motor 10 and the ECU 50 is formed by the motor housing 61 and the motor cover 62. A gear room 65 accommodating the deceleration mechanism section 20 is formed by the motor housing 61 and the gear housing 63.

A socket 61a provided with terminals electrically coupled to the ECU 50 is provided in the motor housing 61. In the motor housing 61, power is supplied to the motor 10, the rotor rotation angle sensor 30, and the output shaft turning angle sensor 40 via the socket 61a and the ECU 50.

The motor 10 has a function of generating rotation drive force for turnably driving the shift switching mechanism section 70. The motor 10 is configured with the rotor 11 that is rotatably supported, and a stator 12 that is disposed to face the rotor 11 with a magnetic gap around the rotor.

The motor 10 is a so-called three-phase motor. Specifically, the rotor 11 has a shaft pinion 11a and a rotor core 11b, and N-pole magnets and S-pole magnets as permanent magnets (not illustrated) are alternately attached to a surface of the rotor core 11b around the turning axis line C1 at an equal angle interval (45°). Therefore, the number of poles of the motor 10 is eight. As a result, an electrical angle of the motor 10 (rotor 11) is four times the (physical) rotation angle of the motor 10.

The shaft pinion 11a is a shaft member that extends in the Z axis direction to communicate through the motor room 64 and the gear room 65. The shaft pinion 11a is configured to be rotatable about the same turning axis line C1 as that of the output shaft 25. A lower part (Z2 side) of the shaft pinion 11a is integrally formed with a gear part 11c in which a gear groove is helically formed. The gear part 11c is a small-numbered teeth helical gear is formed with a small number of teeth and a large torsion angle such that a gear diameter is sufficiently small.

The stator 12 has a stator core 13 fixed into the motor room 64 of the motor housing 61, and an excitation coil 14 (refer to FIG. 1) in a plurality of phases (a U phase, a V phase, and a W phase), generating magnetic force through conduction. The stator core 13 is disposed such that the center thereof matches the turning axis line C1 of the shaft pinion 11a. The stator core 13 is fixed into the motor room 64 by a pair of support shafts 13a extending in the Z axis direction.

In the motor 10, the rotor 11 is configured to be rotated by 15 degrees in the arrow A1 or A2 direction in each (one conduction step) of U-V conduction, U-W conduction, V-W conduction, V-U conduction, W-U conduction, and W-V conduction, and to be rotated by 90 degrees in the arrow A1 or arrow A2 direction in six conduction steps. An arrangement position (magnetization phase) of the N pole and the S pole in the permanent magnet (not illustrated) in the rotor core 11b is apparently returned to the original in the cycle of the six conduction steps. In other words, the cycle of the six conduction steps corresponds to one rotation of an electrical angle of the motor 10.

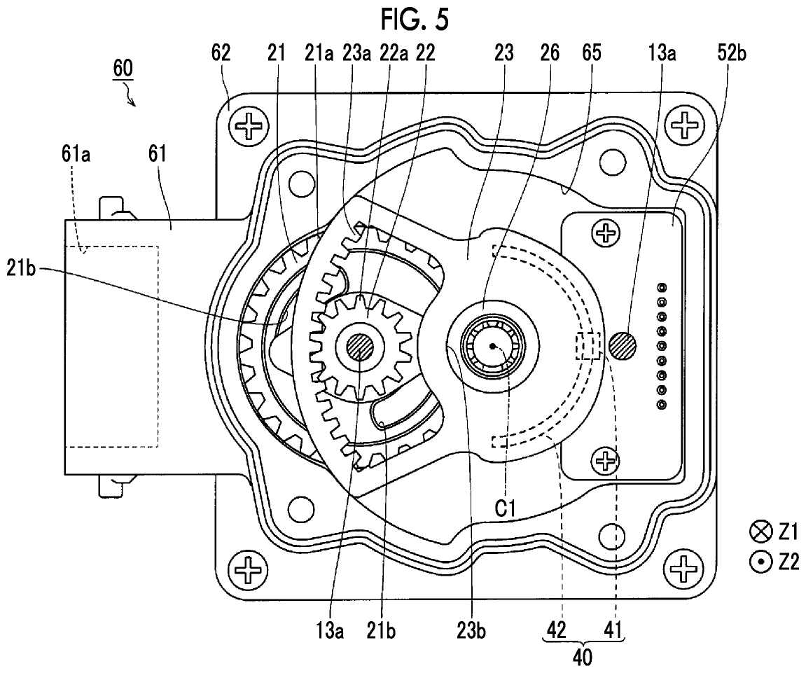

As illustrated in FIGS. 4 and 5, the deceleration mechanism section 20 includes an intermediate gear 21 (an example of a drive section side member), an intermediate gear 22 (an example of a driven section side member), and a final gear 23 respectively having gear parts 21a, 22a, and 23a.

The intermediate gear 21 is configured to be turned about a turning axis line C2 that is different from the turning axis line C1. The turning axis line C2 is a straight line extending in the Z axis direction through the center of one support shaft 13a. The gear part 21a of the intermediate gear 21 is configured to be meshed with the gear part 11c of the rotor 11. In other words, the intermediate gear 21 is provided on the motor 10 side in the deceleration mechanism section 20. As illustrated in FIG. 5, the intermediate gear 21 is circular in a plan view. The gear part 21a is formed at an outer circumference of the intermediate gear 21.

The intermediate gear 22 is configured to be turned about the same turning axis line C2 as that of the intermediate gear 21, and to be disposed on a lower surface side (Z2 side) of the intermediate gear 21. The gear part 22a of the intermediate gear 22 is formed on a lower surface side (Z2 side) of the intermediate gear 22.

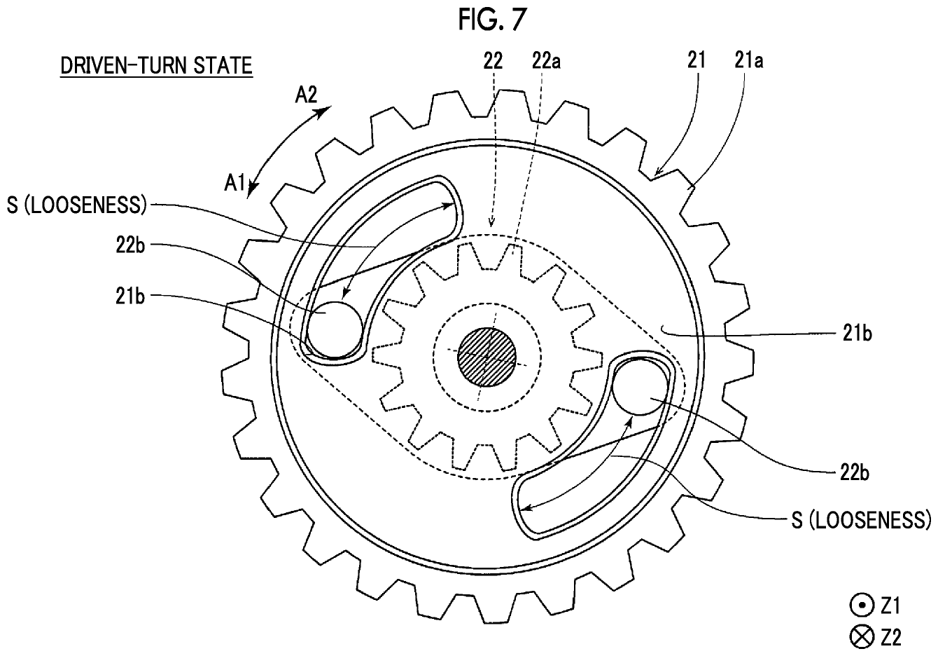

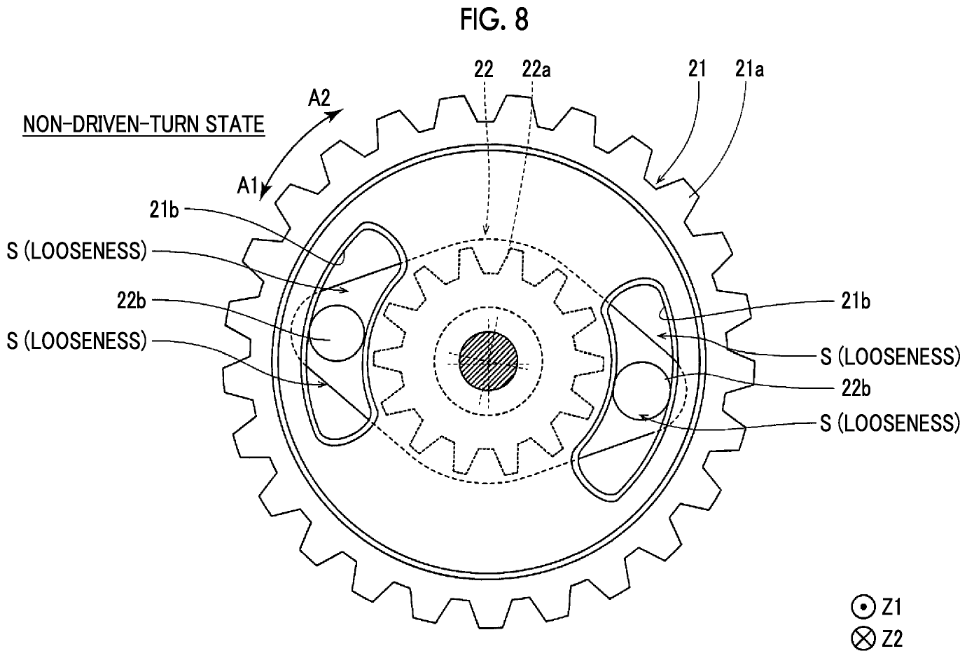

Here, as illustrated in FIGS. 7 and 8, the intermediate gear 21 has a plurality of (two) long holes 21b (an example of a first engagement portion) provided to penetrate through the intermediate gear 21. The long holes 21b are disposed at an interval of 180 degrees in the turning direction of the intermediate gear 21. Each of the plurality of long holes 21b extends in a circular arc shape in the turning direction (A1 or A2 direction) and is a long hole that is longer in the turning direction than in the diameter direction of the intermediate gear 21.

An upper surface (Z1 side) of the intermediate gear 22 is provided with a plurality of (two) columnar engagement protrusions 22b (an example of a second engagement portion and a protrusion) protruding upward (Z1 side). The engagement protrusions 22b are disposed at an interval of 180 degrees at edges on both sides in a major axis direction.

The engagement protrusions 22b disposed at an interval of 180 degrees are configured to be respectively inserted into (engaged with) the two corresponding long holes 21b of the intermediate gear 21 in a state in which the intermediate gear 22 is disposed to be adjacent to the intermediate gear 21 upward (Z1 side) from below. Each of the plurality of engagement protrusions 22b has an outer diameter that is substantially the same as a length of the long hole 21b in a width direction (diameter direction). The plurality of engagement protrusions 22b are formed to be movable in the long holes 21b along the turning direction.

The engagement protrusion 22b is inserted into the long hole 21b of the intermediate gear 21 with a predetermined amount of looseness S (a length of the long hole 21b in a longitudinal direction (turning direction)). In other words, there is a configuration in which relative free turning (free rotation) between the intermediate gear 21 and the intermediate gear 22 is permitted in proportion to the looseness S (predetermined angular width) in the turning direction, occurring between the engagement protrusion 22b and the long hole 21b engaged with each other. Here, the predetermined amount of looseness S has a length obtained by excluding a length occupied by the columnar engagement protrusion 22b from the length of the long hole 21b in the longitudinal direction. The length of the long hole 21b in the longitudinal direction is a length of a circular arc that passes through the center of the long hole 21b in the diameter direction and centers on the center (turning axis line C2) of the intermediate gear 21, and the predetermined amount of looseness S also has a length of a circular arc centering on the center of the intermediate gear 21.

Therefore, the shift switching mechanism section 70 of the shift device 100 is configured to switch between a driven-turn state in which the intermediate gear 22 is turned in accordance with turning of the intermediate gear 21 and a non-driven-turn state in which the intermediate gear 22 is not turned (performs relative free turning) in accordance with turning of the intermediate gear 21. FIG. 7 illustrates the driven-turn state, and FIG. 8 illustrates a non-driven-turn state.

As illustrated in FIG. 5, the gear part 23a of the final gear 23 is configured to be meshed with the gear part 22a of the intermediate gear 22. Specifically, the gear part 23a of the final gear 23 is formed as an inner gear on an inner surface on a side separated from the turning axis line C1 in a fan-shaped long hole extending in a turning direction of the final gear 23. The gear part 22a of the intermediate gear 22 is configured to be disposed in the fan-shaped long hole.

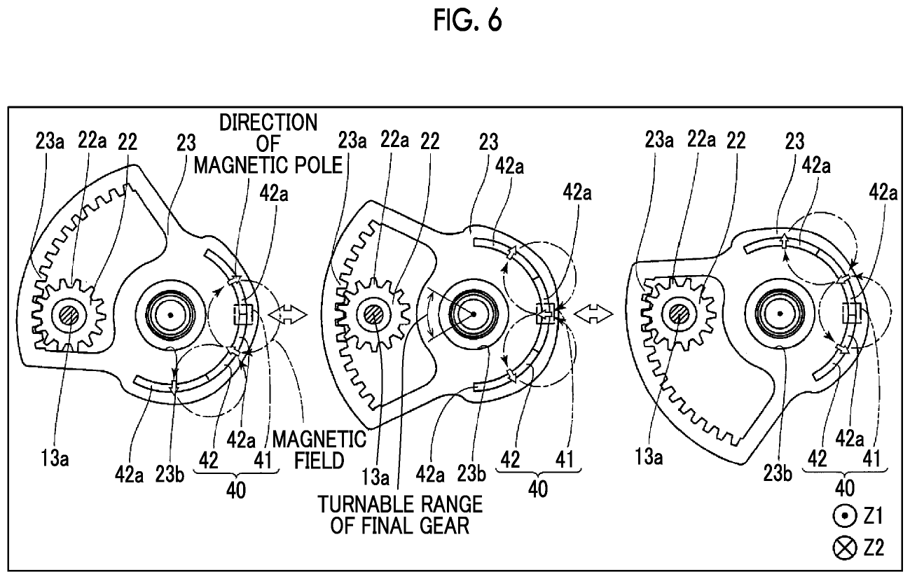

Here, as illustrated in FIG. 6, the gear part 23a of the final gear 23 is formed in an angular range of below 180° C. on the inner surface of the fan-shaped long hole. Consequently, the gear part 22a of the intermediate gear 22 comes into contact with (locked to) the inner surface of the fan-shaped long hole on which the gear part 23a is formed, and thus the final gear 23 is configured to be turnable within a turning range of below 180 degrees. As a result, the output shaft 25 and the shift switching mechanism section 70 (detent plate 71) are configured to be turnable within a turning range of below 180 degrees.

As illustrated in FIG. 4, in the final gear 23, an output bearing part 26 in which the output shaft 25 is fitted is fitted and fixed into a fitting hole 23b. Consequently, the final gear 23 has the same turning axis line C1 as that of the output shaft 25, and can thus be turned at the same turning angle as that of the shift switching mechanism section 70 (detent plate 71).

The deceleration mechanism section 20 is configured to decelerate rotation of the shaft pinion 11a (rotor 11) on the output shaft 25 side by using the intermediate gear 21, the intermediate gear 22, and the final gear 23. Specifically, the deceleration mechanism section 20 is configured such that a deceleration ratio is 1:50. In other words, in a case where the rotor 11 is rotated 50 times (the motor 10 is subjected to 24×50=1200 conduction steps), the output shaft 25 is configured to be turned once. Therefore, in the motor 10, the rotor 11 is rotated by 15 degrees (π/2 (rad) in terms of electrical angle) in one conduction step, and thus the output shaft 25 is turned by 0.3 degrees (=15/50).

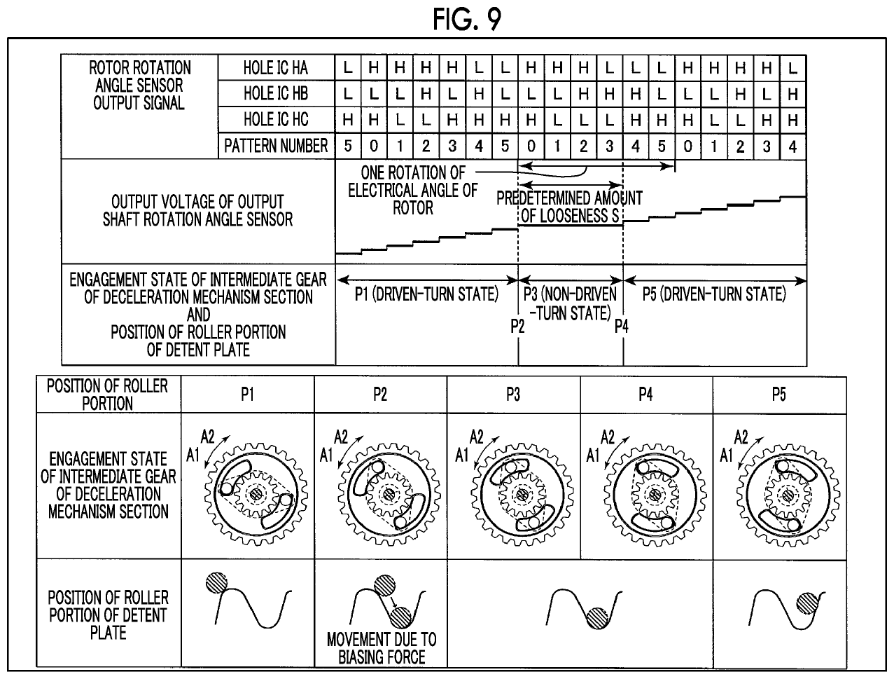

As illustrated in FIG. 4, the rotor rotation angle sensor 30 is a digital encoder that outputs the number of pulses corresponding to a rotation amount (rotor rotation angle) of the rotor 11. In other words, the rotor rotation angle sensor 30 (within a dot chain line) includes three magnetic sensors 31 (HA, HB, and HC; refer to FIG. 9) formed of hole ICs, and a detection magnet 32. The magnetic sensors 31 are mounted at an equal angle (about 120 degrees) interval on the board 52a. The magnetic sensors 31 are configured to output a digital signal (high (H) or low (L)) on the basis of the magnitude of a magnetic field of the magnet 32. The magnet 32 is attached to the upper surface (Z1 side) of the rotor core 11b.

As a result, a digital signal is output from each of the three magnetic sensors 31 provided to face the magnet 32 on the board 52a, and is transmitted to the ECU 50. The ECU 50 is configured to classify six pattern numbers according to the three digital signals. Specifically, the ECU 50 is configured to classify six pattern numbers (rotor rotation angle information) according to the three digital signals.

Specifically, in a case where HA and HC are high (H), and the HB is low (L), the ECU 50 determines that a pattern number is “0”, and, in a case where HA is high (H), and the HB and the HC are low (L), the ECU 50 determines that a pattern number is “1”. In a case where HA and HB are high (H), and the HC is low (L), the ECU 50 determines that a pattern number is “2”, and, in a case where HB is high (H), and the HA and the HC are low (L), the ECU 50 determines that a pattern number is “3”. In a case where HB and HC are high (H), and the HA is low (L), the ECU 50 determines that a pattern number is “4”, and, in a case where HC is high (H), and the HA and the HB are low (L), the ECU 50 determines that a pattern number is “5”.

Here, the ECU 50 is configured to control the motor 10 such that one conduction step in the motor 10 corresponds to increment or decrement of a pattern number by “1”. Specifically, the ECU 50 is configured to increment a pattern number by 1 (or to set a pattern number from “5” to “0”) when the rotor 11 is turned in the arrow A2 direction by one conduction step, and to decrement a pattern number by 1 (or to set a pattern number from “0” to “5”) when the rotor 11 is turned in the arrow A1 direction by one conduction step.

The output shaft turning angle sensor 40 is an analog magnetic sensor that detects magnetic force corresponding to an output angle of the output shaft 25 (the detent plate 71 of the shift switching mechanism section 70), and outputs an analog signal corresponding to the detected magnetic force. In other words, the output shaft turning angle sensor 40 (within a dot chain line) includes magnetic sensors 41 (an example of a magnetic force detection portion) formed of hole ICs and a detection magnet 42 (an example of a magnetic force generation portion). The magnetic sensors 41 are mounted on and fixed to a board 52b as illustrated in FIG. 4. The magnet 42 is attached to the final gear 23.

As illustrated in FIGS. 5 and 6, the magnet 42 is disposed in a semicircular (circular arc) shape in a plan view. In other words, the magnet 42 is disposed an angular range of 180 degrees. As a result, the magnet 42 is disposed in a circular arc shape over a range wider than the turning range (the turning range of below 180 degrees) of (the detent plate 71 of) the shift switching mechanism section 70.

The magnet 42 is divided into three magnetic poles 42a, and is also configured such that directions of magnetic fields due to the adjacent magnetic poles 42a are opposite to each other. As a result, the output shaft turning angle sensor 40 can increase a detectable turning angle (a turning angle (plate turning angle) of the detent plate 71) of the output shaft 25 while maintaining a resolution using the magnetic sensors 41.

The board 52a and the board 52b are electrically coupled to each other via an interconnect 53. The ECU 50 is configured to perform switching control of conduction of the excitation coil 14 and thus to perform shift position switching control in the shift device 100 on the basis of rotor rotation angle information (pattern number) and a plate turning angle (output voltage).

The shift device 100 (motor 10) is configured to switch between a sleep state (an example of a non-startup state) in which the motor 10 is not driven and a wakeup state (an example of a startup state) in which the motor 10 is driven under the control of the ECU 50. In the wakeup state, power is supplied to the motor 10, the rotor rotation angle sensor 30, and the output shaft turning angle sensor 40, and thus shift position switching control is performed by the shift device 100. On the other hand, in the sleep state, the supply of power to the motor 10 is stopped, and the supply of power to the rotor rotation angle sensor 30 and the output shaft turning angle sensor 40 of the shift device 100 is also stopped. Some functions of the ECU 50 are stopped. As a result, in the sleep state, power consumption in the shift device 100 is considerably reduced.

The shift device 100 is caused to transition to the sleep state from the wakeup state by the ECU 50 in a case where sleep state transition conditions are satisfied, for example, when the vehicle 110 provided with the shift device 100 is stopped, when the engine 150 is not ignited, and when signal transmission from the ECU 151 is stopped. The shift device 100 is caused to transition to the wakeup state from the sleep state by the ECU 50 in a case where wakeup state transition conditions are satisfied, for example, when the vehicle 110 is started, when the engine 150 is newly ignited, and when signal transmission from the ECU 151 is resumed.

Here, in the sleep state, the rotor 11 may be unintentionally rotated due to vibration or the like of a constituent component of the shift device 100. In this case, a relative reference position for the motor 10 (rotor 11) of the shift switching mechanism section 70 is deviated, and at least one of a digital signal (pattern number) output from the magnetic sensor 31 of the rotor rotation angle sensor 30 and an output voltage output from the magnetic sensor 41 of the output shaft turning angle sensor 40 during sleep state transition, and a digital signal (pattern number) and an output voltage at the current time also changes. In a case where transition from the sleep state to the wakeup state occurs in a state in which at least one of a digital signal (pattern number) and an output voltage has changed, shift position switching control is performed in a state in which the relative reference position is deviated, and thus the shift position switching control is not accurately performed.

Therefore, in the first embodiment, the ECU 50 is configured to perform a learning process regarding a relative position of the detent plate 71 for the rotor 11 when transition from the sleep state to the wakeup state occurs on the basis of both of a change amount of a rotor rotation angle in the sleep state and the wakeup state and a change amount of a plate turning angle in the sleep state and the wakeup state. In the first embodiment, the learning process regarding a relative position of the detent plate 71 for the rotor 11 indicates a process of returning a relative (angular) position to an original relative reference (angular) position in a case where a relative angular position of a plate turning angle of the detent plate 71 for a rotation angle of the rotor 11. For example, a general wall abutment process or the like is performed under the control of the ECU 50.

For example, a case is assumed in which a pattern number (rotor rotation angle) from the rotor rotation angle sensor 30 changes from “5” to “4” or “0” when transition from the sleep state to the wakeup state occurs. In this case, the ECU 50 determines that a relative angular position of a plate turning angle of the detent plate 71 for a rotation angle of the rotor 11 is deviated, and performs a learning process of returning the relative angular position to an original relative reference angular position.

As illustrated in FIGS. 7 and 8, in the first embodiment, as described above, the shift device 100 is brought into the driven-turn state and the non-driven-turn state due to the predetermined amount of looseness S between the engagement protrusion 22b of the intermediate gear 22 of the detent plate 71 side and the long hole 21b of the intermediate gear 21 of the rotor 11 side. Here, in the non-driven-turn state in which the intermediate gear 22 of the detent plate 71 side is not moved, an output voltage from the magnetic sensor 41 of the output shaft turning angle sensor 40 does not change, and thus turning is required to be determined on the basis of digital signals (pattern number) output from the three magnetic sensors 31 of the rotor rotation angle sensor 30. However, digital signals (pattern number) are the same digital signals (pattern number) for each rotation of an electrical angle of the motor 10, and thus there is concern that the ECU 50 may not accurately recognize a change in a relative position.

Therefore, in the first embodiment, the shift switching mechanism section 70 is configured to switch from the non-driven-turn state to the driven-turn state within a range in which the rotor 11 of the motor 10 is turnably driven by below one rotation of an electrical angle. In other words, the predetermined amount of looseness S is formed to have a size corresponding to an electrical angle of below one cycle (2π (rad)) of an electrical angle of the rotor 11. Specifically, in the first embodiment, since the number of poles of the motor 10 is eight, the predetermined amount of looseness S is configured to be formed as a circular arc (for example, a circular arc of which a central angle is 60 degrees) such that a central angle of the circular arc is less than 90 degrees (=360/4). As a result, switching from the non-driven-turn state in which the intermediate gear 22 of the detent plate 71 side is not moved to the driven-turn state in which the intermediate gear 22 is turned along with the intermediate gear 21 of the rotor 11 is performed before digital signals (pattern number) output from the magnetic sensors 31 are subjected to one rotation, and thus the ECU 50 can accurately recognize a change in a relative position.

With reference to FIG. 9, a detailed description of changes in a pattern number (rotor rotation angle) due to the predetermined amount of looseness S and an output voltage from the output shaft turning angle sensor 40. In FIG. 9, as an example, a description will be made of a case where the intermediate gear 21 is turned in the A2 direction.

First, as in a state P1, in a state in which the roller portion 73 is not fitted into the valley part 71a of the detent plate 71 corresponding to any shift position, the driven-turn state occurs in which the detent plate 71, the output shaft 25, the final gear 23, and the intermediate gear 22 are turned along with the intermediate gear 21 and the rotor 11 by the biasing force F from the detent spring 72. In the driven-turn state, the inner circumferential surface of the long hole 21b on the A1 direction side comes into contact with the outer circumferential surface of the engagement protrusion 22b. In the driven-turn state, an increase in a pattern number and an increase in an output voltage correspond to each other on a one-to-one basis.

Here, in a case where the intermediate gear 21 is further rotated in the A2 direction, a state P2 occurs in which the roller portion 73 is fitted into the valley part 71a of the detent plate 71 corresponding to any shift position by the biasing force F from the detent spring 72. In this case, the intermediate gear 22 is oscillated (turned) precedingly to rotation of the intermediate gear 21 by the predetermined amount of looseness S. The detent spring 72 is fitted into the valley part 71a, and thus oscillation of the detent plate 71 is stopped. In the state P2, the intermediate gear 21 is not rotated, and the intermediate gear 22 is turned, so that the outer circumferential surface of the engagement protrusion 22b is in a state of coming into contact with the inner circumferential surface of the long hole 21b on the A2 direction side.

In a case of the state P2 and a state P3, the engagement protrusion 22b is not pushed in the A2 direction by the long hole 21b of the rotor 11 rotated in the A2 direction, and thus the detent plate 71, the output shaft 25, the final gear 23, and the intermediate gear 22 are brought into the non-driven-turn state of not being rotated (of performing relative free turning) in accordance with rotation of the intermediate gear 21 and the rotor 11. In the non-driven-turn state, a pattern number increases, but an output voltage does not change.

Here, as described above, in the shift device 100 of the first embodiment, the size of the predetermined amount of looseness S is configured to be a size corresponding to an electrical angle of below one cycle (2π (rad)) of an electrical angle of the rotor 11. Consequently, as in a state P4, the inner circumferential surface of the long hole 21b on the A1 direction side comes into contact with the outer circumferential surface of the engagement protrusion 22b again before an electrical angle of the intermediate gear 21 is subjected to relative one rotation. Thus, since a change in a relative position of the detent plate 71 for the rotor 11 is reliably reflected in any one of a change amount of a rotor rotation angle in the sleep state and the wakeup state and a change amount of a plate turning angle in the sleep state and the wakeup state, it is possible to reliably perform a learning process when a relative position changes.

As in a state P5, the shift device 100 is brought into the driven-turn state again in the same manner as in the state P1.

The above-described contents are also applied not only to the wakeup state of the motor 10 but also to the sleep state. In other words, before sleep transition and after wakeup state transition, in a case where a route retrieval prerequisite of a plate turning angle of the detent plate 71 for a rotation angle of the rotor 11 is deviated, a pattern number has a separate value even when an output voltage does not change. As a result, the ECU 50 can accurately recognize a change in a relative position after wakeup state transition.

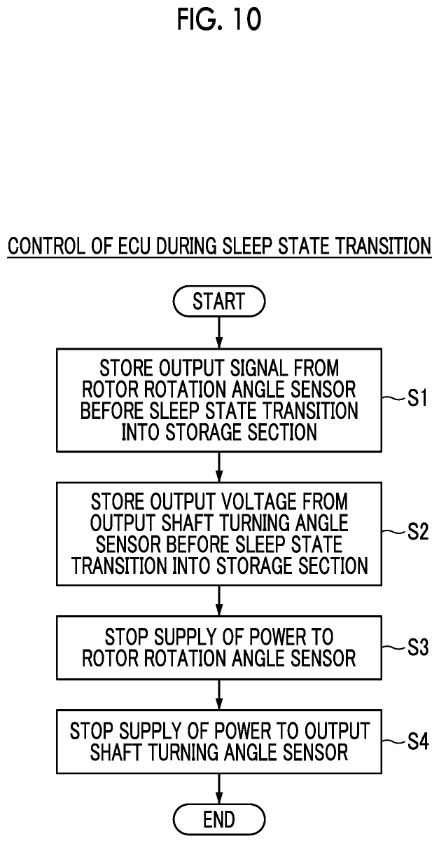

Next, with reference to FIG. 10, a description will be made of a control flow in the ECU 50 during sleep state transition in the first embodiment.

In a case where sleep state transition conditions are satisfied, the ECU 50 stores an output signal (digital signal) from the rotor rotation angle sensor 30 before sleep state transition into the storage section 51 in step S1, and stores an output voltage from the output shaft turning angle sensor 40 before sleep state transition into the storage section 51. Thereafter, in steps S3 and S4, the ECU 50 stops the supply of power to the rotor rotation angle sensor 30 and the output shaft turning angle sensor 40, and finishes the present control flow. In a case where the sleep state transition conditions are satisfied, the ECU 50 also stops the supply of power to the motor 10 in step S2.

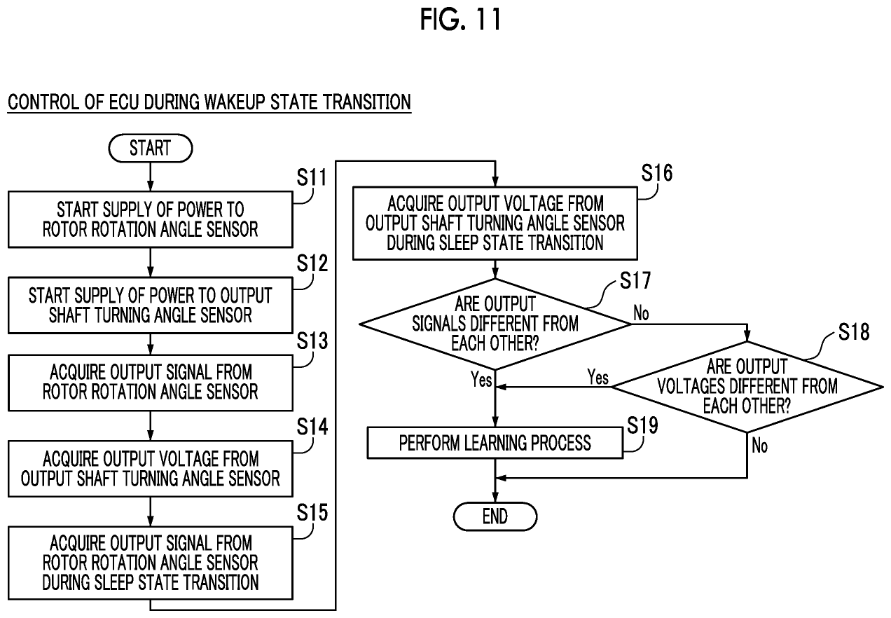

Next, with reference to FIG. 11, a description will be made of a control flow in the ECU 50 during wakeup state transition in the first embodiment.

In steps S11 and S12, in a case where wakeup state transition conditions are satisfied, the ECU 50 starts the supply of power to the rotor rotation angle sensor 30 and the output shaft turning angle sensor 40. In a case where the wakeup state transition conditions are satisfied, the ECU 50 also starts the supply of power to the motor 10. The ECU 50 acquires an output signal (digital signal) from the rotor rotation angle sensor 30 during wakeup state transition in step S13, and acquires an output voltage from the output shaft turning angle sensor 40 during the wakeup state transition in step S14. Thereafter, the ECU 50 acquires an output signal from the rotor rotation angle sensor 30 before sleep state transition from the storage section 51 in step S15, and acquires an output voltage from the output shaft turning angle sensor 40 before the sleep state transition from the storage section 51 in step S16.

In step S17, the ECU 50 determines whether or not the output signal from the rotor rotation angle sensor 30 during the wakeup state transition acquired in step S13 is different from the output signal from the rotor rotation angle sensor 30 before the sleep state transition acquired from the storage section 51 in step S15 (a change amount is not 0). In a case where the output signals are not different from each other, in step S18, the ECU 50 determines whether or not the output voltage from the output shaft turning angle sensor 40 during the wakeup state transition acquired in step S14 is different from the output voltage from the output shaft turning angle sensor 40 before the sleep state transition acquired from the storage section 51 in step S16 (a change amount is less than an allowable threshold value). In a case where the output signals are different from each other in step S17, or in a case where the output voltages are different from each other in step S18, the ECU 50 performs a learning process in step S19. The ECU 50 finishes the present control flow. In a case where the output voltages are not different from each other in step S18, the ECU 50 finishes the present control flow.

In the first embodiment, the following effects can be achieved.

In the first embodiment, as described above, the shift device 100 includes the rotor rotation angle sensor 30 that detects a rotor rotation angle and the output shaft turning angle sensor 40 that detects a plate turning angle. The ECU 50 is configured to perform a learning process regarding a relative position of the shift switching mechanism section 70 for the motor 10 (rotor 11) when transition from the sleep state to the wakeup state occurs on the basis of both of a change amount of a rotor rotation angle in the sleep state and the wakeup state and a change amount of a plate turning angle in the sleep state and the wakeup state. Consequently, it is possible to perform a learning process regarding a relative position of the shift switching mechanism section 70 (detent plate 71) when transition from the sleep state to the wakeup state occurs on the basis of a change amount of the rotor rotation angle and a change amount of the plate turning angle in the sleep state and the wakeup state even though neither the rotor rotation angle sensor 30 nor the output shaft turning angle sensor 40 is subjected to conduction in the sleep state. As a result, it is possible to sufficiently reduce power consumption in the sleep state of the shift device 100. In the sleep state, switching to the wakeup state is not required according to an output change of the rotor rotation angle sensor 30 or the output shaft turning angle sensor 40, and thus it is possible to suppress an increase in power consumption in the shift device 100. As a result, it is possible to perform a learning process regarding a relative position of the shift switching mechanism section 70 when transition from the sleep state to the wakeup state occurs while reducing power consumption in the shift device 100.

In the first embodiment, the shift device 100 includes the rotor rotation angle sensor 30 and the output shaft turning angle sensor 40. Consequently, even in a case where a signal from the output shaft turning angle sensor 40 does not change, it is possible to reliably recognize a rotation position or the like of the rotor 11 of the motor 10 by using a detection result in the rotor rotation angle sensor 30. As a result, it is possible to appropriately perform shift position switching control in the shift device 100.

In the first embodiment, the shift switching mechanism section 70 (detent plate 71) is configured to switch between the driven-turn state in which the shift switching mechanism section 70 is turnably driven in accordance with rotational driving of the motor 10 (rotor 11) and the non-driven-turn state in which the shift switching mechanism section 70 is not turnably driven in accordance with rotational driving of the rotor 11. The shift switching mechanism section 70 is configured to switch to the driven-turn state from the non-driven-turn state within a range in which the rotor 11 is turnably driven by below one rotation in terms of electrical angle. Consequently, in the non-driven-turn state, it is possible to suppress the rotor 11 from being rotated by one or more rotations in terms of electrical angle. As a result, even in a case where a signal from the output shaft turning angle sensor 40 does not change due to the non-driven-turn state of the shift switching mechanism section 70, the shift switching mechanism section 70 can switch to the driven-turn state before a case occurs in which the rotor 11 of the motor 10 is rotated by one or more rotations in terms of electrical angle and thus signals from the rotor rotation angle sensor 30 are the same as each other. Therefore, it is possible to suppress that shift position switching control cannot be appropriately performed in the shift device 100.

In the first embodiment, since the predetermined amount of looseness S is provided between the long hole 21b of the intermediate gear 21 and the engagement protrusion 22b of the intermediate gear 22, the shift switching mechanism section 70 (detent plate 71) is configured to switch from the non-driven-turn state to the driven-turn state in a range in which the rotor 11 of the motor 10 is turnably driven by below one rotation in terms of electrical angle. Consequently, the shift switching mechanism section 70 can be easily configured to switch from the non-driven-turn state to the driven-turn state in a range in which the rotor 11 of the motor 10 is turnably driven by below one rotation in terms of electrical angle by using the deceleration mechanism section 20 in which the predetermined amount of looseness S is provided between the intermediate gear 21 and the intermediate gear 22. A rotation speed or the like of the rotor 11 of the motor 10 can be configured to be appropriately changed when turning drive force is transferred to the shift switching mechanism section 70, by using the deceleration mechanism section 20 having the intermediate gear 21 and the intermediate gear 22.

In the first embodiment, when transition to the sleep state occurs, the ECU 50 is configured to store information regarding a rotor rotation angle and information regarding a plate turning angle into the storage section 51, and then stops the supply of power to the rotor rotation angle sensor 30 and the output shaft turning angle sensor 40. When transition to the wakeup state occurs, the ECU 50 is configured to resume the supply of power to the rotor rotation angle sensor 30 and the output shaft turning angle sensor 40, acquire the information regarding the rotor rotation angle and the information regarding the plate turning angle stored in the storage section 51, and acquire a change amount of the rotor rotation angle in the sleep state and the wakeup state and a change amount of the plate turning angle in the sleep state and the wakeup state. Consequently, the ECU 50 acquires the information regarding the rotor rotation angle and the information regarding the plate turning angle stored into the storage section 51 when transition to the wakeup state occurs, during transition to the wakeup state, and can thus perform a learning process regarding a relative position of the shift switching mechanism section 70 for the rotor 11. The ECU 50 is configured to store information regarding a rotor rotation angle and information regarding a plate turning angle into the storage section 51, and then stop the supply of power to the rotor rotation angle sensor 30 and the output shaft turning angle sensor 40. Consequently, it is possible to quickly and reliably reduce power consumption in the shift device 100 while storing the information regarding the rotor rotation angle and the information regarding the plate turning angle.

In the first embodiment, the output shaft turning angle sensor 40 includes the magnet 42 that is not turned and is stationary, and the magnetic sensor 41 that is turned along with the shift switching mechanism section 70. The magnet 42 is disposed in a circular arc shape over a range wider than a turning range of the shift switching mechanism section 70. Consequently, the magnetic sensor can reliably perform detection in the entire turning range of the shift switching mechanism section 70.

In the first embodiment, the intermediate gear 21 is provided with the long hole 21b, and the intermediate gear 22 is provided with the engagement protrusion 22b that is engaged with the long hole 21b with the predetermined amount of looseness S and to which drive force from the intermediate gear 21 is transferred. The long hole 21b extends in a circular arc shape in the turning direction, and the columnar engagement protrusion 22b inserted into the long hole 21b is formed to have an outer diameter of the substantially same length as a length of the long hole 21b in the width direction. The predetermined amount of looseness S is configured to have a length excluding a length occupied by the columnar engagement protrusion 22b from the length of the long hole 21b in the longitudinal direction. Consequently, the predetermined amount of looseness S is provided between the long hole 21b and the engagement protrusion 22b, and thus the shift switching mechanism section 70 can be easily configured to switch from the non-driven-turn state to the driven-turn state in a range in which the motor 10 is turnably driven by below one rotation in terms of electrical angle.

In the first embodiment, the shift switching mechanism section 70 includes the output shaft 25 that is coupled to the deceleration mechanism section 20 and of which a plate turning angle is detected by the output shaft turning angle sensor 40. Consequently, a turning angle of the output shaft 25 coupled to the deceleration mechanism section 20 is used as a turning angle of the shift switching mechanism section 70 (detent plate 71), and thus the shift device 100 can be configured to easily detect a turning angle of the detent plate 71.

### Second Embodiment

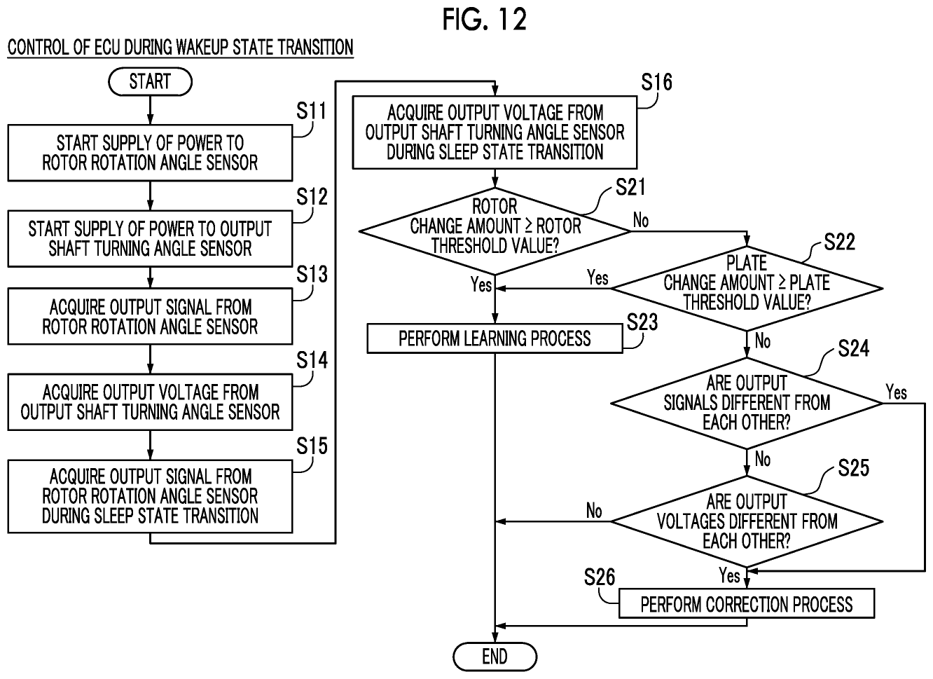

Next, with reference to FIGS. 1 and 12, a second embodiment of the present invention will be described. In the second embodiment, a description will be made of an example in which a learning process is performed in a case where an output signal is equal to or more than a rotor threshold value (an example of a drive section threshold value) or an output voltage is equal to or more than a plate threshold value (an example of a switching mechanism section threshold value) unlike in the first embodiment in which a learning process is performed in a case where an output signal or an output voltage changes. The same constituent element as in the first embodiment will be given the same reference numeral, and description thereof will not be repeated.

A shift device 200 of the second embodiment is provided with an actuator unit 260 including an ECU 250 (an example of a control section). The ECU 250 is configured to perform a learning process or a correction process regarding a relative position of the detent plate 71 for the rotor 11 when transition from the sleep state to the wakeup state occurs on the basis of both of a change amount of a rotor rotation angle in the sleep state and the wakeup state and a change amount of a plate turning angle in the sleep state and the wakeup state. Here, the correction process is a process of changing a relative reference angular position by taking into consideration deviation on the basis of deviation of a relative angular position unlike a process such as wall abutment of returning a relative angular position to an original relative reference angular position.

Specifically, the ECU 250 is configured to perform a learning process regarding a relative position of the shift switching mechanism section 70 (detent plate 71) when return from the sleep state to the wakeup state occurs in a case where a change amount (rotor change amount) of a rotor rotation angle in the sleep state and the wakeup state is equal to or more than a rotor threshold value, or in a case where a change amount (plate change amount) of a plate turning angle in the sleep state and the wakeup state is equal to or more than a plate threshold value.

The ECU 250 is configured to perform a correction process regarding a relative position of the shift switching mechanism section 70 when return from the sleep state to the wakeup state occurs in a case where a change amount of a rotor rotation angle is less than a rotor threshold value and output signals are different from each other (a change amount is not 0) or in a case where a change amount of a plate turning angle is less than a plate threshold value and output voltages are different from each other (a change amount is not 0). Other configurations of the second embodiment are the same as the configurations of the first embodiment. A control flow during sleep state transition according to the second embodiment is the same as the control flow according to the first embodiment.

Next, with reference to FIG. 12, a description will be made of a control flow in the ECU 250 during wakeup state transition according to the second embodiment.

In a case where the wakeup state transition conditions are satisfied, the ECU 250 performs control in steps S11 to S16 in the same manner as in the control flow of the first embodiment.

In step S21, the ECU 250 determines that a change amount (rotor change amount) between the output signal from the rotor rotation angle sensor 30 during wakeup state transition, acquired in step S13, and the output signal from the rotor rotation angle sensor 30 before sleep state transition, acquired from the storage section 51 in step S15, is equal to or more than a rotor threshold value. In a case where the rotor change amount is less than the rotor threshold value, in step S22, the ECU 250 determines that a change amount (plate change amount) between the output voltage from the output shaft turning angle sensor 40 during wakeup state transition, acquired in step S14, and the output voltage from the output shaft turning angle sensor 40 before sleep state transition, acquired from the storage section 51 in step S16, is equal to or more than a plate threshold value. In a case where the rotor change amount is equal to or more than the rotor threshold value in step S21 or in a case where the plate change amount is equal to or more than the plate threshold value in step S22, the ECU 250 performs a learning process in step S23. The ECU 250 finishes the present control flow.

In a case where the plate change amount is less than the plate threshold value in step S22, the ECU 250 determines whether or not the rotor change amount is nonzero (the output signals are different from each other) in step S24. In a case where the rotor change amount is 0, the ECU 250 determines whether or not the plate change amount is nonzero (the output voltages are different from each other) in step S25. In a case where the rotor change amount is not 0 in step S24, or in a case where the plate change amount is not 0 in step S25, the ECU 250 performs a correction process in step S26. The ECU 250 finishes the present control flow. In a case where the plate change amount is 0 in step S25, the present control flow is finished.

In the second embodiment, the following effects can be achieved.

In the second embodiment, as described above, the ECU 250 is configured to perform a learning process regarding a relative position of the shift switching mechanism section 70 for the motor 10 (rotor 11) when transition from the sleep state to the wakeup state occurs on the basis of both of a change amount of a rotor rotation angle in the sleep state and the wakeup state and a change amount of a plate turning angle in the sleep state and the wakeup state. Consequently, in the same manner as in the first embodiment, it is possible to perform a learning process regarding a relative position of the shift switching mechanism section 70 when transition from the sleep state to the wakeup state occurs while reducing power consumption in the shift device 200.

In the second embodiment, the ECU 250 is configured to perform a learning process regarding a relative position of the shift switching mechanism section 70 when return from the sleep state to the wakeup state occurs in a case where a change amount (rotor change amount) of a rotor rotation angle in the sleep state and the wakeup state is equal to or more than a rotor threshold value, or in a case where a change amount (plate change amount) of a plate turning angle in the sleep state and the wakeup state is equal to or more than a plate threshold value. Consequently, in a case where the rotor change amount is less than the rotor threshold value, and the plate change amount is less than the plate threshold value, the ECU 250 can be configured not to perform a learning process, and thus it is possible to suppress an unnecessary learning process in the shift device 200. As a result, in a case where wall abutment control is performed as a learning process, it is possible to suppress an unnecessary load from being applied to the motor 10 or the like.

In the second embodiment, the ECU 250 is configured to perform a correction process regarding a relative position of the shift switching mechanism section 70 when return from the sleep state to the wakeup state occurs in a case where a change amount of a rotor rotation angle is less than a rotor threshold value and output signals are different from each other (a change amount is not 0) or in a case where a change amount of a plate turning angle is less than a plate threshold value and output voltages are different from each other (a change amount is not 0). Consequently, even though a learning process is not performed, deviation of a route relative reference position can be corrected, and thus it is possible to more appropriately perform shift position switching control in the shift device 200 while suppressing an unnecessary load from being applied to the motor 10 or the like. Other effects of the second embodiment are the same as those of the first embodiment.

The present disclosed embodiments may be regarded to be exemplary and not to be limited in all respects. The scope of the present invention is represented by the claims instead of the description of the embodiments, and includes all changes within the claimed scope and the meaning and the scope of equivalents thereof.

For example, in the first and second embodiments, a description has been made of an example in which the intermediate gear 21 of the rotor 11 (rotation drive section) side of the motor 10 is provided with the long hole 21b, and the intermediate gear 22 of the shift switching mechanism section 70 side is provided with the engagement protrusion 22b engaged with the long hole 21b, but the present invention is not limited thereto. For example, the intermediate gear of the rotation drive section side may be provided with an engagement protrusion, and the intermediate gear of the shift switching mechanism section side may be provided with a long hole. The long hole 21b may not penetrate through the intermediate gear 21. For example, instead of a long hole, an engagement portion may be configured with a depressed cam groove having a bottom not penetrating through the intermediate gear 21.

In the first and second embodiments, a description has been made of an example in which the long holes 21b of the intermediate gear 21 are engaged with the engagement protrusions 22b of the intermediate gear 22 at two locations, but the present invention is not limited thereto. In other words, an engagement location between the intermediate gear 21 and the intermediate gear 22 may not be two locations. The engagement location may be one location, and may be three locations.

In the first and second embodiments, a description has been made of a case where the predetermined amount of looseness S is provided between the intermediate gear 21 and the intermediate gear 22, but the present invention is not limited thereto. For example, a predetermined amount of a looseness may be provided between the intermediate gear 22 and the final gear 23. In this case, the intermediate gear 22 corresponds to a “drive section side member” in the claims, and the final gear 23 corresponds to a “driven section side member” in the claims.

In the first and second embodiments, a description has been made of an example in which the magnet 42 (magnetic force generation portion) divided into the three magnetic poles 42a is disposed in a circular arc shape over a range wider than the turning range (the turning range of below 180 degrees) of (the detent plate 71 of) the shift switching mechanism section 70, but the present invention is not limited thereto. In the present invention, the magnetic force generation portion may be formed in a range equal to or narrower than a turning range of the shift switching mechanism section. The magnetic force generation portion may be divided into two magnetic poles or four or more magnetic poles, and may not be divided into magnetic poles.

In the first and second embodiments, a description has been made of an example in which the number of poles of the motor 10 (rotation drive section) is eight, but the present invention is not limited thereto. For example, the number of poles of the rotation drive section may be two, four, six, ten, or twelve. In this case, it is necessary that a predetermined amount of looseness is formed to have a size corresponding to an electrical angle of below one cycle (2π (rad)) of an electrical angle of the rotation drive section. For example, in a case where the number of poles of the rotation drive section is four, a predetermined amount of a looseness is required to be formed in a circular arc of which a central angle is less than 180 degrees (=360/2).

In the first and second embodiments, a description has been made of an example in which the magnet 42 of the output shaft turning angle sensor 40 (switching mechanism section turning angle detection section) is attached to the final gear 23, but the present invention is not limited thereto. In the present invention, the magnet (or a magnetic sensor) of the switching mechanism section turning angle detection section may be attached to the output shaft, and the magnet (or a magnetic sensor) of the switching mechanism section turning angle detection section may be attached to the shift switching mechanism section (for example, the detent plate 71).

In the first and second embodiments, a description has been made of an example in which a surface magnet type (SPM) three-phase motor in which a permanent magnet is incorporated into a surface of the rotor 11 is used as the motor 10, but the present invention is not limited thereto. For example, an embedded magnet type (IPM) motor may be used in which permanent magnets are embedded into the rotor 11 such that polarities (an N poles and an S pole) of magnetic poles switch therebetween at an equal angle interval (for example, an interval of 45°).

In the first and second embodiments, a description has been made of an example in which the shift device of the present invention is applied to a shift device for an automobile (vehicle 110), but the present invention is not limited thereto. The shift device of the present invention may be applied to, for example, shift devices for an aircraft or a ship other than a automobile.

### REFERENCE SIGNS LIST

10 MOTOR (ROTATION DRIVE SECTION)
20 DECELERATION MECHANISM SECTION (DRIVE FORCE TRANSFER MECHANISM)
21 INTERMEDIATE GEAR (DRIVE SECTION SIDE MEMBER)
21b LONG HOLE (FIRST ENGAGEMENT PORTION)
22 INTERMEDIATE GEAR (DRIVEN SECTION SIDE MEMBER)
22b ENGAGEMENT PROTRUSION (SECOND ENGAGEMENT PORTION)
25 OUTPUT SHAFT (OUTPUT SHAFT PORTION)
30 ROTOR ROTATION ANGLE SENSOR (DRIVE SECTION ROTATION ANGLE DETECTION SECTION)
40 OUTPUT SHAFT TURNING ANGLE SENSOR (SWITCHING MECHANISM SECTION TURNING ANGLE DETECTION SECTION)
41 MAGNETIC SENSOR (MAGNETIC FORCE DETECTION PORTION)
42 MAGNET (MAGNETIC FORCE GENERATION PORTION)
50 AND 250 ECU (CONTROL SECTION)
70 SHIFT SWITCHING MECHANISM SECTION
100 AND 200 SHIFT DEVICE
S PREDETERMINED AMOUNT OF LOOSENESS

1. A shift device comprising:
a shift switching mechanism section that switches shift positions;
a rotation drive section that is configured to switch between a startup state and a non-startup state, and generates rotation drive force for turnably driving the shift switching mechanism section;
a drive section rotation angle detection section that detects a drive section rotation angle due to rotation drive of the rotation drive section;
a switching mechanism section turning angle detection section that detects a switching mechanism section turning angle due to turning drive of the shift switching mechanism section; and
a control section that controls the rotation drive section,
wherein the control section is configured to perform a learning process regarding a relative position of the shift switching mechanism section with respect to the rotation drive section when transition from the non-startup state to the startup state occurs on the basis of both of a change amount of the drive section rotation angle in the non-startup state and the startup state and a change amount of the switching mechanism section turning angle in the non-startup state and the startup state.

2. The shift device according to claim 1,
wherein the shift switching mechanism section is configured to switch between a driven-turn state in which the shift switching mechanism section is turnably driven in accordance with rotation drive of the rotation drive section and a non-driven-turn state in which the shift switching mechanism section is not turnably driven in accordance with rotation drive of the rotation drive section, and
wherein the shift switching mechanism section is configured to switch from the non-driven-turn state to the driven-turn state within a range in which the rotation drive section is turnably driven by below one rotation in terms of electrical angle.

3. The shift device according to claim 2, further comprising:
a drive force transfer mechanism that includes a drive side section member provided on the rotation drive section side and a driven section side member provided on the shift switching mechanism section side and turned due to turning of the drive section side member, and that transfers drive force from the rotation drive section side to turnably drive the shift switching mechanism section,
wherein a predetermined amount of a looseness is provided between the drive section side member and the driven section side member, and thus the shift switching mechanism section is configured to switch from the non-driven-turn state to the driven-turn state within a range in which the rotation drive section is turnably driven by below one rotation in terms of electrical angle.

4. The shift device according to claim 1, further comprising:
a storage section that stores information regarding the drive section rotation angle and information regarding the switching mechanism section turning angle,
wherein the control section is configured to, when transition to the non-startup state occurs, store the information regarding the drive section rotation angle and the information regarding the switching mechanism section turning angle into the storage section, and then to stop the supply of power to the drive section rotation angle detection section and the switching mechanism section turning angle detection section, and
wherein the control section is configured to, when transition to the startup state occurs, resume the supply of power to the drive section rotation angle detection section and the switching mechanism section turning angle detection section, to acquire the information regarding the drive section rotation angle and the information regarding the switching mechanism section turning angle stored in the storage section, and to acquire the change amount of the drive section rotation angle in the non-startup state and the startup state and the change amount of the switching mechanism section turning angle in the non-startup state and the startup state.

5. The shift device according to claim 1,
wherein the control section is configured to perform a learning process regarding the relative position of the shift switching mechanism section when return from the non-startup state to the startup state occurs in a case where the change amount of the drive section rotation angle in the non-startup state and the startup state is equal to or more than a drive section threshold value, or in a case where the change amount of the switching mechanism section turning angle in the non-startup state and the startup state is equal to or more than a switching mechanism section threshold value.

6. The shift device according to claim 1,
wherein the switching mechanism section turning angle detection section includes a magnetic force generation portion that is not turned and is stationary, and a magnetic force detection portion that is turned along with the shift switching mechanism section, and
wherein the magnetic force generation portion is disposed in a circular arc shape over a range wider than a turning range of the shift switching mechanism section.

7. The shift device according to claim 3,
wherein the drive section side member includes a first engagement portion, and
wherein the driven section side member includes a second engagement portion that is engaged with the first engagement portion with the predetermined amount of looseness and to which drive force from the drive section side member is transferred.

8. The shift device according to claim 7,
wherein the first engagement portion is a long hole that extends in a circular arc shape in a turning direction,
wherein the second engagement portion is a columnar protrusion that has an outer diameter of the same length as a length of the long hole in a width direction, and is inserted into the long hole, and
wherein the predetermined amount of looseness has a length excluding a length occupied by the columnar protrusion from a length of the long hole in a longitudinal direction.

9. The shift device according to claim 1, further comprising:
a drive force transfer mechanism that transmits drive force from the rotation drive section side to turnably drive the shift switching mechanism section, and
wherein the shift switching mechanism section includes an output shaft portion that is coupled to the drive force transfer mechanism and in which the switching mechanism section turning angle is detected by the switching mechanism section turning angle detection section.
